(19) United States
(12) Patent Application Publication
(10) Pub. No.: US 2005/0083062 A1
(43) Pub. Date: Apr. 21, 2005

(54) Fluid level detection device and methods

(76) Inventor: Philip R. Couch, Honiton (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/934,789

(22) Filed: Sep. 3, 2004

Related U.S. Application Data
(60) Provisional application No. 60/501,021, filed on Sep. 9, 2003.

(51) Int. Cl. G02F 1/295

(52) U.S. Cl. 324/337

(57) ABSTRACT

A fluid level measurement device includes a cable arranged to penetrate fluid to be measured at least to a measurement depth. The cable has first and second conductors. The fluid imposes a dielectric constant on the cable. The device also includes a signal generating arrangement configured to introduce an input signal into the cable and a signal receiving arrangement configured to receive a reflected signal from the cable. The device also includes analysis circuitry configured to analyze the reflected signal in the time domain to thereby determine a depth of at least one fluid interface.

### CROSS-REFERENCES TO RELATED APPLICATIONS

This application is a non-provisional of, and claims the benefit of, co-pending U.S. Provisional Application No. 60/501,021, entitled “FLUID LEVEL DETECTION DEVICES,” filed on Sep. 9, 2003, by Philip R. Couch, the entire disclosure of which is herein incorporated by reference for all purposes.

### BACKGROUND OF THE INVENTION

Embodiments of the present invention relate generally to measurement systems. More specifically, embodiments of the present invention relate to systems and methods for measuring fluid levels, especially multiphase liquids, using time-domain reflectometry.

Measuring the depth of phase interfaces of multiphase liquids in tanks, wells, and the like is difficult for a number of reasons. For example, the interface between liquids may be hidden from view below the surface of the top liquid, requiring one to make this measurement through a liquid. Further, it can be more difficult to detect a liquid/liquid interface than a liquid/air interface. Further still, with respect to specific solutions for making these measurements, phase interfaces may be poorly defined, liquids may adhere to probe measurement instruments, and other realities complicate the problem. Low cost solutions are needed that address these and other challenges.

### BRIEF SUMMARY OF THE INVENTION

Embodiments of the invention thus provide a measurement device. The measurement device includes transmitting means for transmitting a signal through a fluid, depth-wise, at least to a measurement depth. The fluid comprises a dielectric constant imposed on the transmitting means. The measurement device also includes receiving means for receiving a reflected signal from the transmitting means and analyzing means for analyzing the reflected signal in the time domain to thereby determine a depth of at least one fluid interface. The fluid may be a multi-phase liquid and at least one of the fluid interfaces may be an air/liquid interface. At least one of the fluid interfaces may be an oil/water interface.

In other embodiments, a fluid level measurement device includes a cable arranged to penetrate fluid to be measured at least to a measurement depth. The cable has first and second conductors. The fluid imposes a dielectric constant on the cable. The device also includes a signal generating arrangement configured to introduce an input signal into the cable and a signal receiving arrangement configured to receive a reflected signal from the cable. The device also includes analysis circuitry configured to analyze the reflected signal in the time domain to thereby determine a depth of at least one fluid interface.

In some embodiments of the fluid measurement device, a first fluid interface may be an air/liquid interface and a second fluid interface may be an oil/water interface. The cable may be a television flat downlead. The device may include electromagnetically-reflective indexes attached to the cable at predetermined intervals to thereby produce measurement indexes in the reflected signal. The cable may have third and fourth conductors, and the first and second conductors generally define a first plane, and the third and fourth conductors generally define a second plane. The cable may have a plurality of electromagnetically-reflective indexes positioned at predetermined locations through at least a portion of a length of the cable, a first portion of which indexes lie generally parallel to the first plane, and a second portion of which indexes lie generally parallel to the second plane. The individual ones of the first portion of the plurality of indexes and individual ones of the second portion of the plurality of indexes may be positioned at alternating locations.

In other embodiments, a method of measuring fluid level includes placing a multi-conductor cable into a fluid at least to a measurement depth, driving an input signal into the cable, sensing a reflected signal from the cable, and analyzing the reflected signal to locate a level of at least one fluid interface. Driving an input signal into the cable may include driving a differential signal having a generally consistent frequency. Sensing a reflected signal may include sampling the reflected signal at a different frequency from the input signal frequency.

In still other embodiments, a cable includes a plurality of conductors adapted to receive an input signal, transport the input signal to at least a measurement depth in a multi-phase liquid, receive a reflected signal, and return the reflected signal to an analysis arrangement. At least two of the plurality of conductors are arranged generally parallel, thereby defining a plane throughout at least a portion of a length of the cable. The cable also includes a cable jacket at least partially surrounding the plurality of conductors. The plurality of conductors are arranged such that, throughout a phase of the liquid, the liquid imposes a generally consistent dielectric constant on the cable, thereby influencing the reflected signal.

In embodiment of the cable, the cable may include a plurality of electromagnetically-reflective indexes located at pre-determined intervals throughout at least a portion of the length of the cable. At least two of the plurality of conductors may be a first conductor pair defining a first plane throughout at least a portion of the length of the cable and at least two of the plurality of conductors may be a second conductor pair defining a second plane throughout at least the portion of the length of the cable. The planes may intersect and one conductor may be common to both planes. The planes may be generally parallel. The cable also may include a plurality of electromagnetically-reflective indexes located at predetermined intervals throughout at least a portion of the length of the cable. A first portion of the plurality of indexes may lie generally parallel to the first plane and a second portion of the plurality of indexes may lie generally parallel to the second plane. The jacket may be poly(tetrafluoroethylene) (PTFE), fluoro-ethylpropylene (FEP), and/or polyvinyl chloride (PVC).

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an exemplary fluid measurement system according to embodiments of the present invention.

FIG. 2 illustrates exemplary input and output signals according to embodiments of the present invention.

FIG. 3 illustrates an oscilloscope trace according to an embodiment of the invention.

FIG. 4 illustrates a cross section of a first exemplary cable that may be used with the system of FIG. 1.

FIG. 5 illustrates a cross section of a second exemplary cable that may be used with the system of FIG. 1.

FIG. 6 illustrates a perspective view of a cable that may be used with the system of FIG. 1, which cable may be the cable illustrated in FIG. 5.

FIG. 7 illustrates a cross section of a third exemplary cable that may be used with the system of FIG. 1.

FIG. 8 depicts a method according to embodiments of the invention, which method may be embodied in the system of FIG. 1.

### DETAILED DESCRIPTION OF THE INVENTION

Embodiments of the invention relate to fluid measurements systems and associated methods. Exemplary embodiments employ time domain reflectometry technology to analyze signals reflected from fluid phases, thereby determining the depth of each phase in multiphase liquids. Generally, a transmission line (i.e., cable) transports an input signal to a measurement depth and receives a reflected signal. The input signal typically is a differential signal having a consistent frequency. The liquid imposes a dielectric constant on the transmission line that influences the reflected signal. As different liquids impose different dielectric constants, voltage levels in the reflected signal correlate to fluid phases. Further, the voltage levels may provide an indication of the composition of the fluid at the relative depth.

Embodiments of the invention are particularly useful for measuring the depths of phase interfaces for multiphase liquids in tanks and wells. If the total volume of the vessel is known, then the volume of each liquid phase may be determined based on the depth of the phase interface. Such knowledge is particularly useful with respect to measuring oil and water levels in oil production and processing operations.

A device according to embodiments of the invention typically includes an electronics package and a cable configured to penetrate the subject fluid. The cable typically is unshielded and consists of at least two conductors. A termination resistor and/or weight may be attached to one end of the cable, which is lowered into the fluid, at least to the depth to be measured.

The electronics assembly typically includes signal generation and signal sampling circuitry. Some embodiments include analysis circuitry. Other embodiments are configured to transport information representative of the sampled signal to an analysis device. The electronics assembly may be solar powered and may be configured to wirelessly transport information to other locations. The electronics assembly may be configured to transmit information periodically, upon interrogation, or both.

In some embodiments, the reflected signal is analyzed directly; in others, the reflected signal may be sampled at frequencies different from that of the input signal. By sampling at a frequency that is a fraction of the input signal, the reflected waveform may be sampled at different locations throughout a cycle. The results may be averaged, thereby reducing the influence of noise.

Electromagnetically-reflective indexes may be placed at regular intervals on or in the cable. The indexes produce measurement indexes in the reflected signal that may be used to more accurately analyze the reflected signal. In some examples, the cable may include multiple conductor pairs, which may be arranged orthogonally with indexes arranged alternately along each orthogonal pair. The conductor pairs may be driven alternately, as will be described in more detail below, to provide a choice of signals such that one signal may be selected that suffers the least interference from an index lying close to the desired surface reflection.

While the following description relates generally to embodiments configured to measure multiphase liquids including oil and water, those skilled in the art will appreciate many other examples in light of this description.

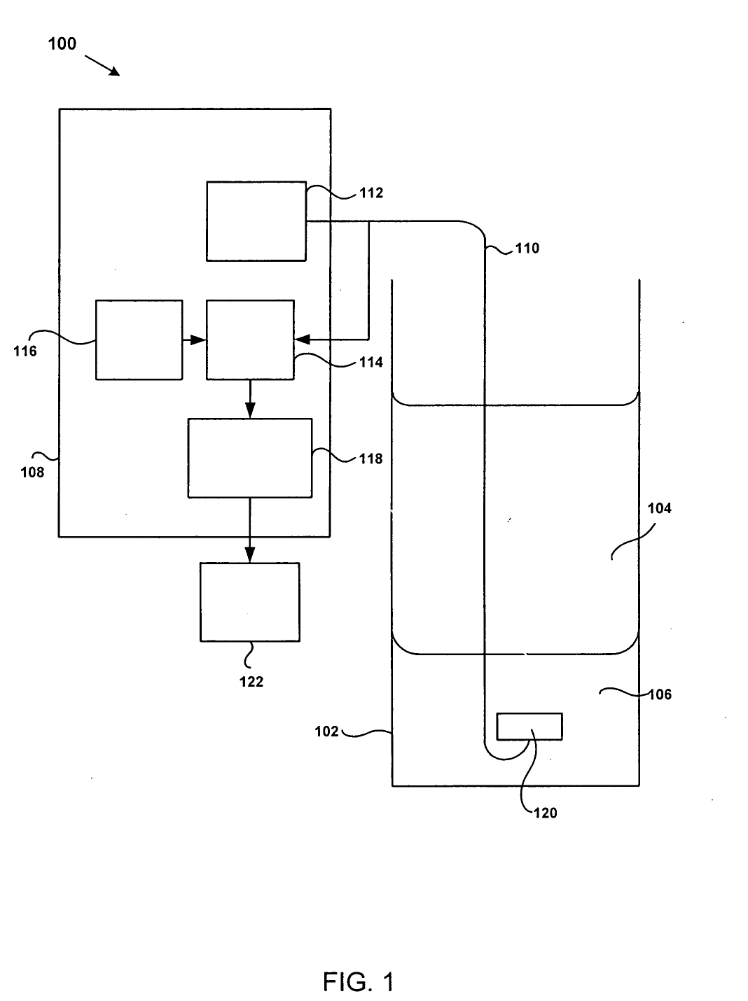

Having described embodiments of the present invention generally, attention is directed to FIG. 1, which illustrates a specific embodiment of a fluid level measurement system 100. In the embodiment illustrated, the system 100 is adapted to measure the level of fluid in a tank 102. The fluid is the tank may be a multiphase liquid, as is the case in the embodiment illustrated. In this embodiment, the fluid comprises oil 104 and water 106, although the invention is not limited to measuring the levels of oil and water, or even of liquids having only two phases. Many different fluids having a plurality of phases may be measured according to embodiments of the invention. Further, phase interfaces of multiphase liquids need not be well defined. As will be described in more detail hereinafter, embodiments of the invention may measure, and even characterize, phase interfaces of varying dimensions.

The system 100 includes an electronics assembly 108 and a cable 110. In this embodiment, the electronics assembly 108 includes a signal generation circuit 112, a signal sampling circuit 114, a sampling signal generator 116, and an analysis circuit 118. The cable 110 may be any of a variety of embodiments, as will be described in more detail hereinafter. Generally, however, the cable receives an input signal from the signal generation circuit 112, and transports a reflected signal to the signal sampling circuit 114.

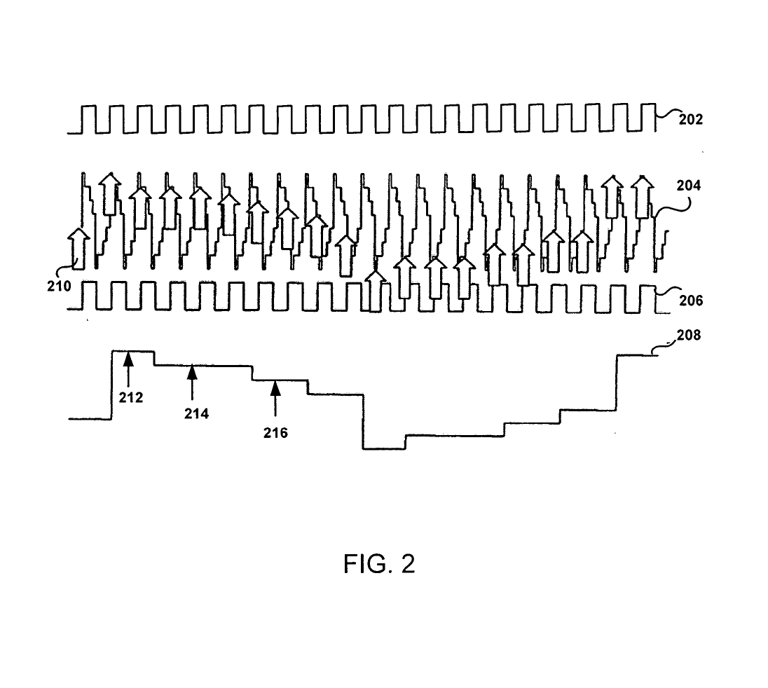

The signal generation circuit 112 may be high speed logic gates, diode pulse generators, high speed line drivers, discrete component designs, and/or the like. Other examples are possible. The input signal may be any of a variety of signal waveforms, an example of which is illustrated in FIG. 2. In this exemplary embodiment, the input signal 202 is a high speed, differential signal, in this case a square wave, having a fixed frequency. Other examples include impulse waveforms, sine waveforms, and the like.

FIG. 2 also illustrates an exemplary reflected signal 204. In the exemplary system 100, the signal sampling circuit 114 is positioned close to the point at which the input signal is driven into the cable 110. Each cycle of the input signal produces a cycle in the output signal having different voltage levels for different media through which the signal propagates. The signal sampling circuit 114 may simply pass the analog signal to the analysis circuit 118 unaltered. In some embodiments, however, the sampling circuit 114 samples the signal in a variety of ways, as will be explained in more detail hereinafter.

Although the reflected signal 204 may be analyzed directly, the signal may be sampled and analyzed as a sequence of samples. Illustrations related to one particular sampling method provide greater resolution with respect to the reflected signal and will, therefore, be used hereinafter for ease of illustration. Those skilled in the art will realize, however, that the resultant waveform referred to below may simply be the unaltered reflected signal 204.

In this embodiment, the signal sampling circuit 114 uses a high-speed sampling circuit and an analog to digital converter to convert the samples to digital form. The sampling signal, generated by the sampling signal generator 116, typically is fixed but may vary slightly from the frequency of the input signal 202, as is the case in this exemplary embodiment. Here, the received signal is sampled once in each cycle of the input signal, but at a slightly different point in each cycle. FIG. 2 illustrates an exemplary sample signal 206, an exemplary resultant waveform 208, and arrows 210 indicating the points in time at which the reflected signal 202 is sampled to form the resultant waveform 208. In the illustrated embodiment, the reflected signal 202 is sampled at the rising edge of each cycle of the sample signal 206.

In the embodiment illustrated in FIG. 2, the signal sampling circuit samples the reflected waveform at a rate very slightly less than the input signal. Thus each successive sample is taken from a point in the next cycle that is just slightly later in the waveform than the sample time in the previous cycle. The samples thus taken, from many cycles of the input signal, provide the same shape waveform but stretched in time. The new waveform repeats fully each time the sampling signal gains or loses one complete cycle relative to the input signal. Thus, for example, if the sampling signal frequency differs from the input signal frequency by one percent, then the sampled waveform is a replica of the original waveform expanded in time by 100 times. In practice the difference between the input signal frequency and the sample signal frequency may be only a few parts per million, mainly in order to take samples very closely spaced in the reflected waveform to achieve a faithful reconstruction, but also in order to expand the reflected waveform timescale to something much more easily processed.

As is apparent, after an interval of cycles of the input signal, the signal sampling circuit 114 has sampled points throughout a reflected signal cycle. These samples are stored in memory, such as a RAM buffer, with storage positions in the RAM being synchronized with a corresponding position of the sample relative to the input signal cycle. As a result, successive samples from the same time sample position can be added to the memory location each time the sample process cycles through. The data thus stored in each RAM location may be the average of many real-time samples, reducing the effects of noise and interference, such as radio signals, impinging on the cable.

The analysis circuit 118 may be a micro-controller, or the like. In the specific embodiment illustrated here, the analysis circuit 118 reads the RAM contents using time parameters not necessarily controlled by the sampling rate. The analysis circuit 118 also may perform signal processing. Time-domain reflectometry (TDR) processing may be used to analyze the reflected signal samples (or the analog signal in embodiments that do not sample the reflected signal).

The resultant waveform 208, which will be understood to be either the unaltered analog reflected signal, a signal sampled at the same frequency as the input signal, or a signal sampled at a frequency different than the frequency of the input signal, is affected by reflection points along the cable 110 back to the cable input. Reflections from the different characteristics of propagation in each of the different media and from the cable end are shown. By analyzing the waveform, the thickness of each fluid layer is determined.

At point 212 of the resultant waveform 208, the voltage of the reflected signal is the highest. In this example, this corresponds to the portion of the cable in air above the liquid level in the tank 102. The impedance of the cable in air is highest because the dielectric constant of air is lowest at approximately 1.0. The impedance in oil, which has a dielectric constant of approximately 2.2, is lower, and the reflected voltage is lower as indicated by point 214 on the resultant waveform 208. The impedance in water is lower still so that the reflected voltage is lower as indicated by point 216.

As will be described, a number of different cable embodiments may be employed in connection with the system 100. The combined impedance seen at the input/sample end by the cable 110 may be designed to be as close as possible to the cable characteristic impedance in air in order to reduce double reflections back into the top of the cable. A termination resistor 120 may be positioned at the opposite end of the cable 110 and sized to match the characteristic impedance of the cable in water (or the fluid at the lowest measurement depth) to minimize reflections from that end of the cable. A weight (not shown) may be used to pull the cable taught and straight.

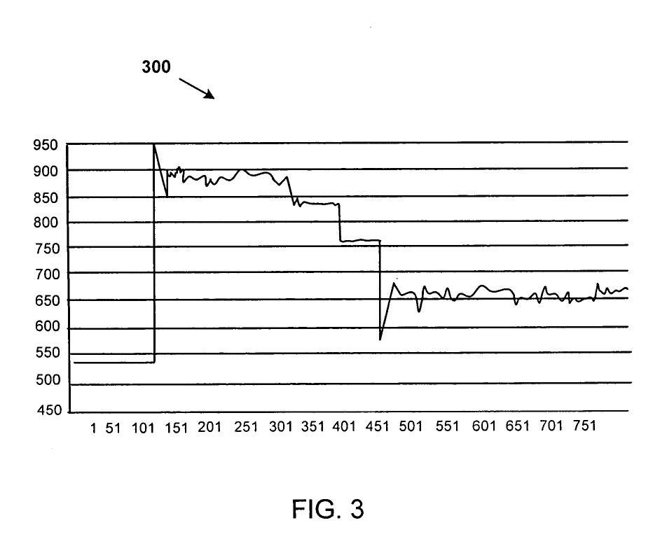

The system 100 also may include an oscilloscope 122 or other output viewing device. An exemplary oscilloscope trace is illustrated in FIG. 3.

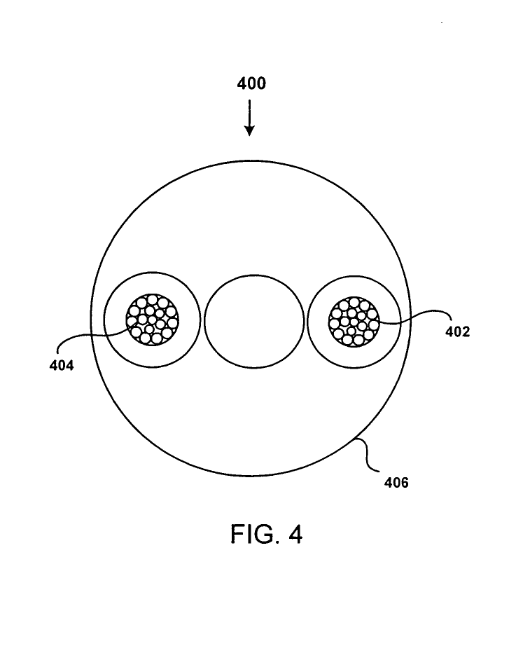

Attention is directed to FIG. 4, which illustrates a cross section of an exemplary cable 400 according to embodiments of the invention. The cable 400 is a round, two-core cable having a first conductor 402 and a second conductor 404 covered by a jacket 406. The conductors 402, 404 may be any appropriate electrically conductive material. In a specific embodiment, the conductors 402, 404 are multi-strand wires in the gauge range 6-16. The jacket 406 need not be around each individual conductor, but may encompass the entire cable as shown. The cable also may be generally flat, such as a television flat downlead know in the art. Any suitable material known to those of skill in the art may be employed for the jacket 406. The material may be capable of shrinkage to fit snugly around the cable, similar to a heat shrink material. Jacket material choices include poly(tetrafluoroethylene) (PTFE), fluoro-ethylpropylene (FEP), polyvinyl chloride (PVC), and the like. In some embodiments, the jacket material comprises a non-stick material that resists adhesion by contaminants. Especially in oil, the outside surface tends to become coated with material that modifies the speed of propagation in the cable and distorts the measurements. The use of non-stick materials, such as fluoropolymers, for the cable jacket 406 helps to reduce contamination. In addition to protecting the conductors and resisting adhesion of contaminates, the jacket material also may be selected to reduce the sensitivity of the cable to surrounding media, which may reduce the inaccuracies caused by contamination. The cable also may include a core 408, which may be a semi-rigid material that provides additional structure and dimensional stability for the cable 400 and also aids in penetrating the fluid being measured.

Despite the use of non-stick materials for the cable jacket, contaminants nevertheless may adhere to the cable. For this and other reasons, indexes may be used to improved measurement accuracy. Essentially, indexes are electromagnetically-reflective features placed or formed in or on the cable at pre-determined locations. Indexes cause an impedance discontinuity that registers as a detectable signal reflection and may be used to more accurately determine fluid levels. Thus, indexes create a virtual ruler in the reflected signal. In some embodiments, indexes are made of a conductive material known to those of skill in the art, such as thin, conductive plates. In some embodiments, indexes may be crimps in the cable or other alteration. Many other examples are possible.

Even when indexes are used, fluid features near an index may be obscured by or rendered inaccurate by the signal reflected from the index. This is especially the case if a phase interface occurs at an index location. For this reason, some embodiments employ two cables having indexes at alternating locations. Thus, features that may be obscured by one index while one cable is driven nevertheless may be observed in the reflected signal produced during a cycle of the other conductor pair because the index is in a different position relative to the interface.

In two cable embodiments such as this, the first cable may be driven alternately with the second cable by a high-speed logic gate. Reflecting signals from both cables may be summed into the same signal sampling circuit 114 and then separated again into two RAM buffers. The analysis circuit 118 may choose data from either or both RAM buffers for analysis. Alternatively, two separate driver and receiver circuits may be used for each cable. The receiver circuit in each case may consist of a high speed track-and-hold circuit followed by an analog to digital converter.

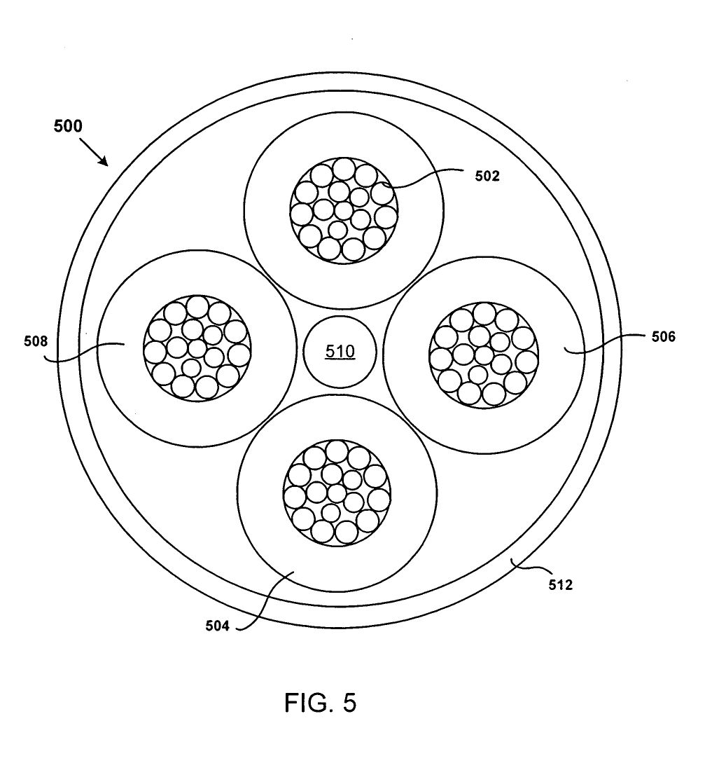

Attention is directed to FIG. 5, which illustrates an exemplary cable 500 according to embodiment of the present invention. The cable 500 has four conductors 502, 504, 506, 508 arranged in orthogonal pairs, conductors 502 and 504 being the first pair, and conductors 506 and 508 being the second pair. The first and second pairs may be driven as the two separate cables described above. The orthogonal arrangement of the conductor pairs minimizes the electrical coupling between the pairs. The cable 500, like the cable 400, also may have a semi-rigid core 510 and a jacket 512 made of the same materials described above with respect to the cable 400.

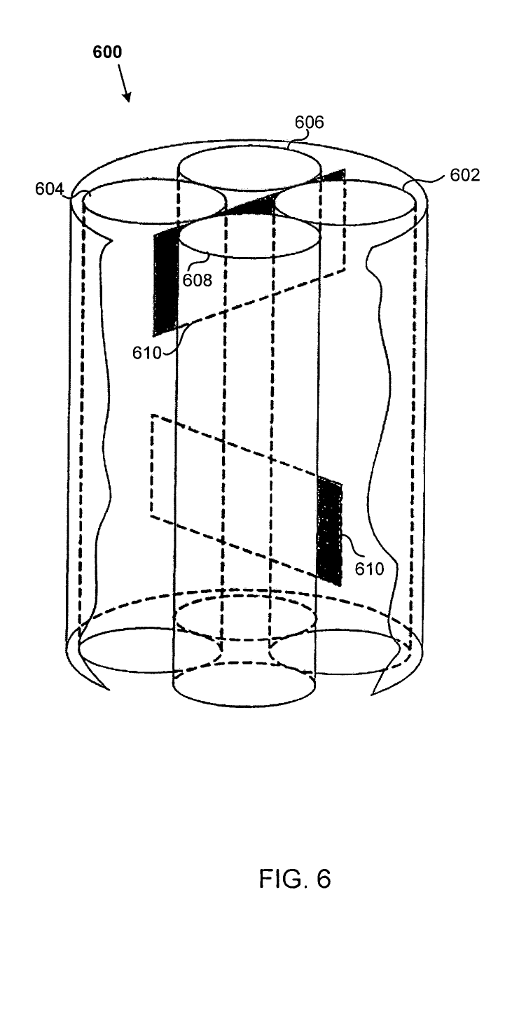

As previously described, electromagnetically-reflective indexes may be attached to or formed on the cable 500 at predetermined locations. FIG. 6 illustrates an embodiment of a cable similar to cable 500 having such indexes.

The cable 600 is similar to the cable 500 of FIG. 5. It includes four conductors 602, 604, 606, 608, that may be driven alternately as described previously. In the embodiment of FIG. 6, indexes 610 are placed at known positions along and internal to the cable. In the embodiment illustrated in FIG. 6, alternating sets of indexes 610 are positioned between different pairs of conductors to provide independent measurements. Although alternate indexes are positioned between different pairs of conductors in FIG. 6, the indexes may all be positioned between the same pairs at known intervals along the cable. Those skilled in the art will realize, however, that indexes are not limited to embodiments having two conductor pairs. Indexes also may be used with cable embodiments such as the cable 400 and many others.

Although the preceding paragraph described driving opposing conductors as a conductor pair, other embodiments drive the conductors in different pair arrangement (e.g., adjacent conductors driven as a pair). Those skilled in the art will appreciate, in light of this disclosure, that different arrangements of conductor pairs and indexes make conductors more or less visible in the reflected signal (i.e., have more or less affect on the field based on the relative orientation). Many other examples are possible.

In another embodiment, a visible ruler scale (not shown) may be employed in combination with the indexes 610. The ruler scale may be internal to the cable, making it necessary to have a transparent non-stick sheath material, such as a fluoropolymer sheath, to view the scale. The ruler scale may aid in locating the indexes and may provide visual confirmation of fluid levels.

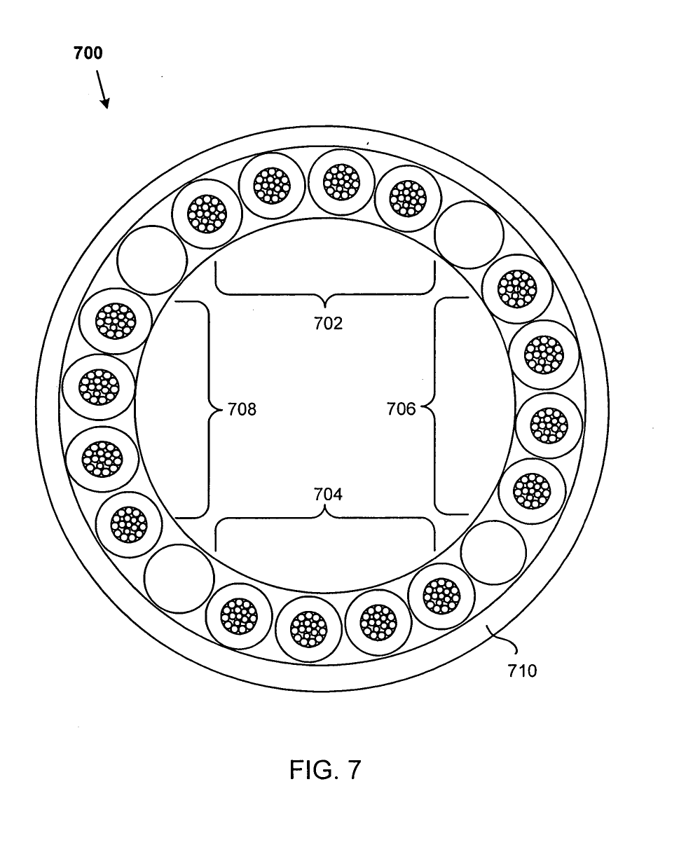

Attention is directed to FIG. 7, which depicts another exemplary embodiment of a cable 700. The cable 700 employs four, 4-conductor groups 702, 704, 706, 708. Using conductor groups with the conductors positioned at or near the periphery of the cable, such as depicted in this example, presents a larger surface area to the external medium, which enhances the ability to sense changes in the surrounding dielectric constant of the external media being measured. In addition to providing greater sensitivity to the external medium, this arrangement also allows a thicker dielectric jacket 710 to be used on the cable 700 which may reduce sensitivity to contamination on the outside surface. The cable 700 may be fitted with indexes as previously described.

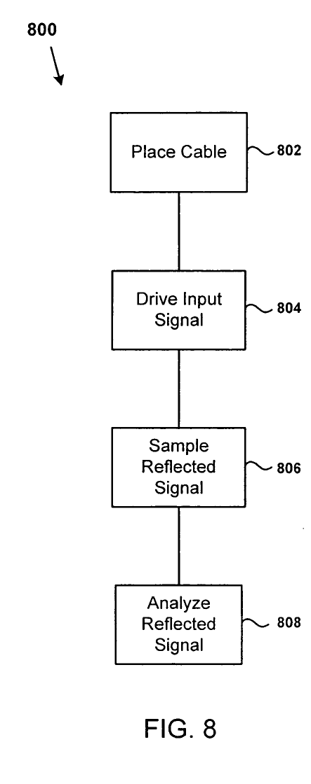

FIG. 8 illustrates a method 800 of measuring fluid according to embodiments of the invention. The method may be implemented in the device 100 of FIG. 1, or other suitable device. Those skilled in the art will appreciate that the method 800 is merely exemplary and that other embodiments may have more, fewer, or different steps than those shown here. The method begins at block 802, at which point a multi-conductor cable, such cable 110, is placed into the fluid to be analyzed. The cable is lowered at least to the depth for which a measurement is desired. For purposes of this example, the fluid will be assumed to be a multi-phase liquid having at least oil and water phases. The phases need not be particularly well defined. In this example, the objective is to determine approximately how much oil is in the vessel. The oil is floating on top of the water.

At block 804, an input signal is driven into the cable. The input signal, in this example, is a square wave having a frequency of 2 MHz, although suitable frequencies may be up to 10 MHz. In other embodiments, input signals outside this range may be used. The input signal is driven into one conductor pair or conductor group of the cable.

At block 806, a reflected signal is sampled from the cable. The input signal is influenced, in the time domain, by the fluid through which the input signal is traveling to produce the reflected signal. Thus, at block 808, the reflected signal is analyzed to attempt to determine the level of each phase interface in the multi-phase liquid.

As previously described, the reflected signal may include indexes produced by measurement indexes in the cable. Further, the reflected signal may include an area that indicated an extended phase transition in the fluid being measured. In such cases, analyzing the reflected signal may include characterizing the phase transition region. This may include, for example, quantifying the dielectric constant of the phase transition material, thereby providing an indication of the material's composition. Those skilled in the art will appreciate, in light of this disclosure, other types of analyses that may be performed on the reflected signal.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. For example, those skilled in the art know how to manufacture and assemble electrical devices and components. Additionally, those skilled in the art will realize that the present invention is not limited to measuring oil/water mixtures. Embodiments of the present invention may be configured to measure phase interface levels of many different fluids. Accordingly, the above description should not be taken as limiting the scope of the invention, which is defined in the following claims.

1. A measurement device, comprising:
transmitting means for transmitting a signal through a fluid, depth-wise, at least to a measurement depth, wherein the fluid comprises a dielectric constant imposed on the transmitting means;
receiving means for receiving a reflected signal from the transmitting means; and
analyzing means for analyzing the reflected signal in the time domain to thereby determine a depth of at least one fluid interface.

2. The measurement device of claim 1, wherein the fluid comprises a multi-phase liquid and wherein at least one of the fluid interfaces comprises an air/liquid interface.

3. The measurement device of claim 2, wherein at least one of the fluid interfaces comprises an oil/water interface.

4. A fluid level measurement device, comprising:
a cable arranged to penetrate fluid to be measured at least to a measurement depth, the cable having first and second conductors, wherein the fluid comprises a dielectric constant imposed on the cable;
a signal generating arrangement configured to introduce an input signal into the cable;
a signal receiving arrangement configured to receive a reflected signal from the cable; and
analysis circuitry configured to analyze the reflected signal in the time domain to thereby determine a depth of at least one fluid interface.

5. The fluid level measurement device of claim 4, wherein a first fluid interface comprises an air/liquid interface.

6. The fluid level measurement device of claim 5, wherein a second fluid interface comprises an oil/water interface.

7. The fluid level measurement device of claim 4, wherein the cable comprises a television flat downlead.

8. The fluid level measurement device of claim 4, further comprising electromagnetically-reflective indexes attached to the cable at predetermined intervals to thereby produce measurement indexes in the reflected signal.

9. The fluid level measurement device of claim 4, wherein the cable has at least third and fourth conductors, wherein the first and second conductors generally define a first plane, and wherein the third and fourth conductors generally define a second plane, the cable further comprising a plurality of electromagnetically-reflective indexes positioned at predetermined locations through at least a portion of a length of the cable, a first portion of which indexes lie generally parallel to the first plane, and a second portion of which indexes lie generally parallel to the second plane.

10. The fluid level measurement device of claim 9, wherein the individual ones of the first portion of the plurality of indexes and individual ones of the second portion of the plurality of indexes are positioned at alternating locations.

11. A method of measuring fluid level, comprising:
placing a multi-conductor cable into a fluid at least to a measurement depth;
driving an input signal into the cable;
sensing a reflected signal from the cable; and
analyzing the reflected signal to locate a level of at least one fluid interface.

12. The method of claim 11, wherein driving an input signal into the cable comprises driving a differential signal having a generally consistent frequency.

13. The method of claim 12, wherein sensing a reflected signal comprises sampling the reflected signal at a different frequency from the input signal frequency.

14. A cable, comprising:
a plurality of conductors adapted to:
receive an input signal;
transport the input signal to at least a measurement depth in a multi-phase liquid;
receive a reflected signal; and
return the reflected signal to an analysis arrangement;
wherein at least two of the plurality of conductors are arranged generally parallel, thereby defining a plane throughout at least a portion of a length of the cable; and
a cable jacket at least partially surrounding the plurality of conductors;
wherein the plurality of conductors are arranged such that, throughout a phase of the liquid, the liquid imposes a generally consistent dielectric constant on the cable, thereby influencing the reflected signal.

15. The cable of claim 14, further comprising a plurality of electromagnetically-reflective indexes located at pre-determined intervals throughout at least a portion of the length of the cable.

16. The cable of claim 14, wherein at least two of the plurality of conductors comprise a first conductor pair defining a first plane throughout at least a portion of the length of the cable, wherein at least two of the plurality of conductors comprise a second conductor pair defining a second plane throughout at least the portion of the length of the cable.

17. The cable of claim 16, wherein the planes intersect and wherein one conductor is common to both planes.

18. The cable of claim 16, wherein the planes are generally parallel.

19. The cable of claim 16, further comprising a plurality of electromagnetically-reflective indexes located at predetermined intervals throughout at least a portion of the length of the cable.

20. The cable of claim 19, wherein a first portion of the plurality of indexes lie generally parallel to the first plane, and wherein a second portion of the plurality of indexes lie generally parallel to the second plane.

21. The cable of claim 14, wherein the jacket comprises a jacket material selected from the group consisting of poly(tetrafluoroethylene) (PTFE), fluoro-ethylpropylene (FEP), and polyvinyl chloride (PVC).
